(19) United States
(12) Patent Application Publication
(10) Pub. No.: US 2025/0390880 A1
(43) Pub. Date: Dec. 25, 2025

(54) SMART PEER GROUPING OF BANK CUSTOMERS USING FUZZY K-MODE

(71) Applicant: ACTIMIZE LTD, Ra'anana (IL)

(72) Inventors: Sumit KUMAR, Pune (IN); Sunny THOLAR, Pune (IN); Prasad MHATRE, Pune (IN)

(21) Appl. No.: 18/752,248

(22) Filed: Jun. 24, 2024

(51) Int. Cl. G06Q 20/40

(52) U.S. Cl. CPC G06Q 20/4016

(57) ABSTRACT

A system is adapted to automatically identify suspected mule accounts. It includes a processor performing operations: identifying a number of desired clusters for grouping entities; for each dimension in a multidimensional space, defining each cluster as a Gaussian distribution in each dimension. For each entity: for each cluster: calculating a distance between the entity and the cluster, and a probability that the entity belongs to the cluster; and recalculating the Gaussian distributions until each entity belongs to at least one. The operations also include, for an entity, in real time: receiving a transaction associated with the entity; based on a cluster to which the entity belongs, determining a peer anomaly score indicative of a probability that the transaction is anomalous; and if the peer anomaly score exceeds a threshold value, reporting the transaction and the entity to a user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to a systems, devices, and methods for identifying peer groups among banking customers. This smart peer grouping system has particular but not exclusive utility for anti-money laundering (AML) investigation.

### BACKGROUND

In fraud analysis, such as anti-money laundering (AML), entities such as transaction originators and recipients may be grouped into clusters of similar individuals or peers. In a non-limiting example, one cluster might contain students, while a second cluster contains working class individuals, a third cluster contains highly paid professionals, and a fourth cluster contains retirees. Other types and numbers of clusters are possible, and may be used instead or in addition.

However, AML detection often involves detecting subtle and complex patterns across multiple transaction categories. Money launderers employ sophisticated techniques involving multiple layers of transactions to conceal their activities. Traditional clustering methods may oversimplify the grouping of individuals or transactions, potentially missing nuanced relationships and multi-layered structures.

It is therefore to be appreciated that such commonly used clustering or peer grouping methods have numerous drawbacks, including incompleteness, low accuracy, and otherwise. Accordingly, long-felt needs exist for improved peer grouping methods that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a smart peer grouping system, which allows entities (e.g., individuals or businesses) to belong to more than one cluster, to partially or probabilistically belong to a cluster, and to be more accurately analyzed for peer anomalies (e.g., behavior that is uncharacteristic of a given peer group). The smart peer grouping system disclosed herein has particular, but not exclusive, utility for anti-money laundering investigation.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically identify suspected mule accounts. The system includes a fraud management server having at least one processor and a non-transitory computer readable medium operably coupled thereto, the server being in electronic communication with a computing device of a bank, the processor may include a distance calculation module and an expectation maximization clustering module, the server being in electronic communication with a database for storing a plurality of features for a plurality of entities associated with the bank, the computer readable medium may include a plurality of instructions stored in association therewith that are accessible to, and executable by, the processor, to perform operations which may include: receiving an input identifying a number of desired clusters for a plurality of clusters; in a multidimensional space may include one dimension for each feature of the plurality of features, defining each cluster of the plurality of clusters as a Gaussian distribution in each dimension of the multidimensional space; for each entity of the plurality of entities: for each cluster of the plurality of clusters: calculating a distance between the entity and the cluster; and based on the distance, calculating a probability that the entity belongs to the cluster. The operations also include, based on the probabilities and an expectation maximization, recalculating the Gaussian distributions until each entity belongs to at least one cluster of the plurality of clusters; for an entity of the plurality of entities, in real time: receiving at least one transaction associated with the entity; based on a cluster to which the entity belongs, determining a peer anomaly score indicative of a probability that the at least one transaction is anomalous; and if the peer anomaly score exceeds a threshold value, reporting the at least one transaction and the entity to a user. Other embodiments of this aspect include corresponding computer systems, apparatus, and computer programs recorded on one or more computer storage devices, each configured to perform the actions of the methods.

Implementations may include one or more of the following features. In some embodiments, the entity belongs to more than one cluster of the plurality of clusters. In some embodiments, the entity belonging to more than one cluster of the plurality of clusters improves an accuracy of the peer anomaly score. In some embodiments, the entity belonging to more than one cluster of the plurality of clusters improves an accuracy of the clusters for describing a behavior of the entity. In some embodiments, the improved accuracy of the clusters improves the utility of the clusters for anti-money-laundering (AML) analysis. In some embodiments, the entity belonging to more than one cluster of the plurality of clusters reduces an amount of time required to calculate the clusters. In some embodiments, the entity belonging to more than one cluster is based on a first probability of the entity belonging to a first cluster being within a threshold difference from a second probability of the entity belonging to a second cluster. In some embodiments, the plurality of features includes numeric features and non-numeric features, and for numeric features, a corresponding component of the distance is calculated using a probability, and for non-numeric features, the corresponding component of the distance is calculated using a Hamming distance. In some embodiments, the numeric features include at least one of a net worth, an annual income, an account key, a party key, a monthly deposit amount, a monthly transaction volume, or a number of active days per month. In some embodiments, the non-numeric features include at least one of a suspicious entity identifier, a suspicious financial institution identifier, an occupation, a party type, an account category, or an account classification. Implementations of the described techniques may include hardware, a method or process, or computer software on a computer-accessible medium.

One general aspect includes a computer-implemented method for automatically identifying suspected mule accounts. The computer-implemented method includes, with a fraud management server having at least one processor and a non-transitory computer readable medium operably coupled thereto, the server being in electronic communication with a computing device of a bank, the processor including a distance calculation module and an expectation maximization clustering module, the server being in electronic communication with a database for storing a plurality of features for a plurality of entities associated with the bank: receiving an input identifying a number of desired clusters for a plurality of clusters; in a multidimensional space including one dimension for each feature of the plurality of features; defining each cluster of the plurality of clusters as a Gaussian distribution in each dimension of the multidimensional space; for each entity of the plurality of entities: for each cluster of the plurality of clusters: calculating a distance between the entity and the cluster; and based on the distance, calculating a probability that the entity belongs to the cluster. The method also includes, based on the probabilities and an expectation maximization, recalculating the Gaussian distributions until each entity belongs to at least one cluster of the plurality of clusters; for an entity of the plurality of entities, in real time: receiving at least one transaction associated with the entity; based on a cluster to which the entity belongs, determining a peer anomaly score indicative of a probability that the at least one transaction is anomalous; and if the peer anomaly score exceeds a threshold value, reporting the at least one transaction and the entity to a user. Other embodiments of this aspect include corresponding computer systems, apparatus, and computer programs recorded on one or more computer storage devices, each configured to perform the actions of the methods.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the smart peer grouping system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is schematic, diagrammatic representation, in block diagram form, of an example anti-money laundering investigation system, in accordance with at least one embodiment of the present disclosure.

FIG. 2 is a schematic diagram of a processor circuit, according to embodiments of the present disclosure.

FIG. 3 is a one-dimensional representation of entities in a multidimensional space, in accordance with at least one embodiment of the present disclosure.

FIG. 4 is a schematic, diagrammatic representation of an example cluster initialization process, in accordance with at least one embodiment of the present disclosure.

FIG. 5 is a schematic, diagrammatic representation of a Gaussian model update process, in accordance with at least one embodiment of the present disclosure.

FIG. 6 is a schematic, diagrammatic representation of a Gaussian model convergence process, in accordance with at least one embodiment of the present disclosure.

FIG. 7 is a schematic, diagrammatic representation of a completed cluster assignment, in accordance with at least one embodiment of the present disclosure.

FIG. 8 is a schematic, diagrammatic representation of data clustering, in accordance with at least one embodiment of the present disclosure.

FIG. 9 is a schematic, diagrammatic comparison between hard clustering and soft clustering of fuzzy k-mode clustering, in accordance with at least one embodiment of the present disclosure.

FIG. 10 is a schematic, diagrammatic representation of a peer anomaly detection process, in accordance with at least one embodiment of the present disclosure.

FIG. 11 shows a flow diagram of an example anomaly detection method according to at least one embodiment of the present disclosure.

FIG. 12 is a representation of an example isolation forest model, in accordance with at least one embodiment of the present disclosure.

FIG. 13 is a schematic, diagrammatic representation, in block diagram form, of at least a portion of an example anti-money laundering investigation system, in accordance with at least one embodiment of the present disclosure.

FIG. 14 shows a screen display of an example anti-money laundering investigation system, in accordance with at least one embodiment of the present disclosure.

FIG. 15 shows a screen display of an example anti-money laundering investigation system, in accordance with at least one embodiment of the present disclosure.

FIG. 16 shows a screen display of an example anti-money laundering investigation system, in accordance with at least one embodiment of the present disclosure.

FIG. 17 shows a screen display of an example anti-money laundering investigation system, in accordance with at least one embodiment of the present disclosure.

FIG. 18 shows a screen display of an example anti-money laundering investigation system, in accordance with at least one embodiment of the present disclosure.

FIG. 19 is a schematic, diagrammatic representation of an alert prioritization method, in accordance with at least one embodiment of the present disclosure.

FIG. 20 is a graph of the “monthly cash deposit value” signal or feature over a 12-month period, in accordance with at least one embodiment of the present disclosure.

FIG. 21 is a graph of the “monthly cash deposit volume” signal or feature over a 12-month period, in accordance with at least one embodiment of the present disclosure.

### DETAILED DESCRIPTION

In accordance with at least one embodiment of the present disclosure, a smart peer grouping system is provided that allows entities to belong to more than one cluster, to partially or probabilistically belong to a cluster, and to be more accurately analyzed for peer anomalies (e.g., behavior that is uncharacteristic of a given peer group).

Current clustering solutions support a one-to-one mapping between entities (e.g., individuals, businesses, or organizations interacting with a financial institution) and clusters (e.g., identified peer groups of entities), but in the real world, some individuals, businesses, or organizations may fit the criteria to belong to multiple clusters. Therefore, the present disclosure provides a more sophisticated method for smart peer grouping. This method goes beyond traditional clustering methods to capture complex patterns and multi-layered structures in AML data. It has flexible mapping, which is unlike the current solution's one-to-one mapping. Rather, the present disclosure allows for entities to belong to multiple clusters, providing flexibility to accommodate the diverse patterns observed in AML transactions.

While algorithms like K-means, mode, and median support hard clustering only, the present disclosure advantageously leverages one or more advanced methods capable of smart peer grouping, enabling better detection of suspicious activities.

The present disclosure may leverage existing initiatives such as suspicious activity monitoring (SAM) predictive models and peer anomaly detection to enhance the detection capabilities by integrating smart peer grouping into the AML framework. The present disclosure addresses the need for more sophisticated algorithms and flexible mapping techniques to effectively detect and prevent money laundering activities by capturing complex patterns and multi-layered structures in transaction data.

The present disclosure implements soft clustering or fuzzy clustering using the Expectation Maximization (EM) algorithm of a Gaussian mixture model to address the limitations of traditional hard clustering methods in anti-money laundering (AML) efforts.

Identifying Clusters: An initial step is to identify the number of clusters to split the dataset into. This allows for a more flexible approach compared to hard clustering, where each observation belongs to exactly one cluster.

Defining Gaussian Models: For each identified cluster, a randomly initialized, multivariate Gaussian model is generated, with one dimension for each feature represented by the cluster. Features may include information about the entity such as an occupation, net worth, average monthly transaction total, etc. These Gaussian models represent the statistical distribution of the data within each cluster, allowing for a probabilistic representation of the cluster.

Probability Calculation: For every observation in the dataset (e.g., an individual entity), the method calculates the probability that it belongs to each cluster. This probability assignment is based on the likelihood of the observation given the parameters of each Gaussian model.

Updating Gaussian Models: Using the probabilities obtained in the previous step, the method updates the parameters of the Gaussian models to better fit the data. This iterative process refines the Gaussian models to better represent the underlying structure of the dataset.

Convergence: The method repeats the probability calculation and model updating steps until a convergence criterion is met. Convergence occurs when the assignments of observations to clusters stabilize, indicating that the algorithm has reached a stable solution (e.g., when further iterations of the probability calculation and model updating steps do not change the cluster assignments).

By employing soft/fuzzy clustering with the EM algorithm of a Gaussian mixture model, the present disclosure overcomes the limitations of traditional hard clustering methods in AML efforts. It allows for more nuanced and probabilistic assignment of observations to clusters, capturing complex patterns and multi-layered structures in transaction data. This approach enhances the detection capabilities of AML systems by providing a more accurate representation of the underlying data distribution and facilitating the identification of suspicious activities.

While traditional clustering methods, such as K-means, use hard assignments where each observation belongs to exactly one cluster, the present disclosure employs soft/fuzzy clustering using Gaussian mixture models (GMMs). This allows for a more probabilistic representation of cluster assignments, where observations have probabilities of belonging to multiple clusters simultaneously.

Enhanced Detection Capabilities: By capturing complex patterns and multi-layered structures in transaction data, the present disclosure enhances the detection capabilities of AML systems. It enables the identification of subtle relationships and sophisticated money laundering techniques that may be missed by traditional clustering methods.

Integration with Existing Systems: The present disclosure can integrate with existing AML tools and systems, to enhance their detection capabilities. By incorporating soft/fuzzy clustering with Gaussian mixture models into the AML framework, the present disclosure complements existing solutions and strengthens overall detection efforts.

Overall, the present disclosure offers a more sophisticated and flexible approach to clustering in the context of AML, which may advantageously permit better detection of suspicious activities, improved protection against money laundering threats, and/or increased ability to investigate money laundering that has occurred.

The present disclosure integrates soft/fuzzy clustering with Gaussian mixture models for anti-money laundering (AML) efforts. Utilizing the Expectation Maximization (EM) algorithm, this addresses complex AML challenges by allowing entities to belong to multiple clusters simultaneously. Its inventive approach provides a nuanced representation of AML data, not readily achievable with traditional methods. This solution requires domain expertise and creatively applies clustering techniques to the specific needs of the AML domain.

This may, for example, advantageously result in enhanced detection accuracy, increased adaptability to evolving threats, reduced false positives, improved automation and efficiency, quicker response to emerging threats, cost savings, improved regulatory compliance, and improved customer experience.

In summary, the present disclosure significantly enhances anti-money laundering (AML) efforts by improving detection accuracy, streamlining compliance processes, reducing costs, and providing deeper insights into financial transactions. By integrating soft/fuzzy clustering with Gaussian mixture models and leveraging the Expectation Maximization (EM) algorithm, the present disclosure offers a sophisticated approach to AML data analysis, ensuring regulatory compliance and maintaining a competitive edge in the financial services industry.

The present disclosure aids substantially in anti-money laundering investigation (e.g., identification of mule accounts), by improving the ability to identify peer groups to which an entity belongs. Implemented on a fraud management computer system in communication with a database and a financial institution computer system, the smart peer grouping system disclosed herein provides practical methods for identifying the expected behavior of an entity based on which peer groups it belongs to. This improved peer grouping transforms a one-for-one clustering process into one where entities can belong to more than one cluster, without the normally routine need for manual discovery and analysis on the part of a fraud analyst. This unconventional approach improves the functioning of the fraud management computer system, typically by improving both the speed and accuracy of peer anomaly detection.

The smart peer grouping system may be implemented as a process at least partly viewable on a display, and operated by a control process executing on a processor that accepts user inputs from a keyboard, mouse, or touchscreen interface, and that is in communication with one or more databases, whether on the fraud management computer system itself, or on the financial institution computer system. In that regard, the control process performs certain specific operations in response to different inputs or selections made at different times. Certain outputs of the smart peer grouping system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the smart peer grouping system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

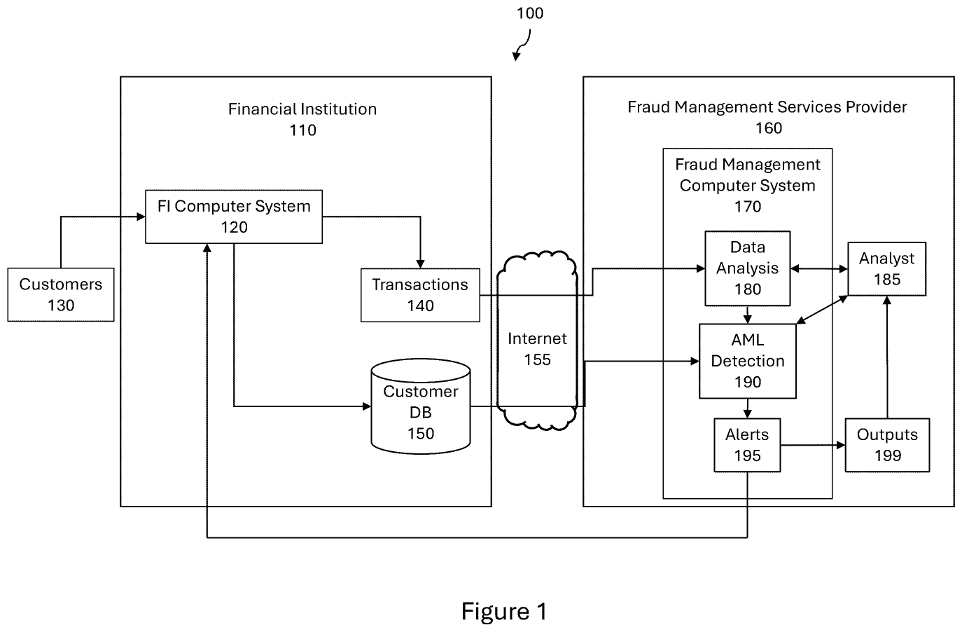

FIG. 1 is schematic, diagrammatic representation, in block diagram form, of an example anti-money laundering investigation system 100, in accordance with at least one embodiment of the present disclosure. The system 100 includes a financial institution 110 and a fraud management services provider 160. The financial institution 110 includes a financial institution computer system 120 that received inputs from customers 130 whose characteristics and transactions may be stored in a customer database 150. Transactions 140 generated by the customers 130 (e.g., sent by or received by the customers 130) are sent via the Internet 155 to a data analysis module 180 running on a fraud management computer system 170 of the fraud management services provider 160. Outputs of the data analysis module 180 are received by an anti-money laundering detection module 190, which may also receive data from the customer database 150. Transactions that are calculated to be suspicious result in alerts 195, which may be transmitted back to the financial institution computer system 120 and/or displayed as outputs 199 to an analyst 185, who also interacts with (e.g., issues instructions to and receives outputs from) the data analysis module 180 and AML detection module 190.

The FI computer system 120 may for example be a centralized computing system managing customer data and processing transactions, and may consist of high-performance servers, possibly configured in a redundant setup for high availability. It may include multiple CPUs, substantial RAM (e.g., 64 GB or more), and high-speed storage arrays (e.g., solid state drives (SSDs) or non-volatile memory express (NVMe) drives).

The customer DB 150 may for example be a database storing detailed customer information, including account details, transaction history, and personal data, and may utilize a robust database server with significant storage capacity (e.g., several terabytes), optimized for read/write operations, often employing redundant array of independent disks (RAID) configurations for data redundancy and integrity.

The fraud management computer system 170 may for example be a specialized computing system responsible for analyzing transactions and detecting fraudulent activities, and may include high-performance servers similar to those used in the FI computer system 120, often with additional computational power (e.g., graphics processing units (GPUs) or tensor processing units (TPUs)) for machine learning tasks.

Data analysis 180 may for example be the step, module, or component that processes transaction data to identify patterns and anomalies, and may involve distributed computing clusters or dedicated analytics servers with enhanced processing capabilities.

Anti-money laundering (AML) detection 190 may for example be the step, module, or component that flags suspicious activities based on predefined criteria and regulatory requirements, and may involve specialized servers with optimized configurations for real-time processing and large-scale data handling.

The analysts 185 may for example be human analysts who review flagged alerts and perform further investigation if necessary, and may make use of workstations with high-resolution monitors, ample memory (e.g., 32 GB RAM), and fast processors to handle large datasets and complex queries.

The outputs 199 may for example be the results of the analysis and detection processes, which can include reports, dashboards, and actionable insights. Backend servers generating reports may for example involve supported by business intelligence tools hosted on powerful servers or cloud infrastructure.

With this configuration, the anti-money laundering investigation system 100 is able to identify and intercept fraudulent transactions that may be associated with money laundering.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Before continuing, it should be noted that the examples described above are provided for purposes of illustration, and are not intended to be limiting. Other devices and/or device configurations may be utilized to carry out the operations described herein.

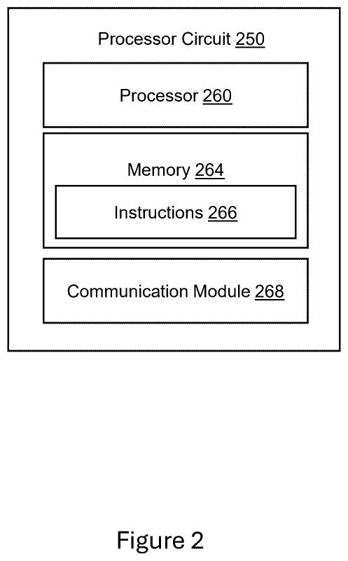

FIG. 2 is a schematic diagram of a processor circuit 250, according to embodiments of the present disclosure. The processor circuit 250 may be implemented in the system 100, or other devices or workstations (e.g., third-party workstations, network routers, etc.), or on a cloud processor or other remote processing unit, as necessary to implement the method. As shown, the processor circuit 250 may include a processor 260, a memory 264, and a communication module 268. These elements may be in direct or indirect communication with each other, for example via one or more buses.

The processor 260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 260 may also comprise another hardware device, a firmware device, or any combination thereof configured to perform the operations described herein. The processor 260 may also be implemented as a combination of computing devices, e.g., a combination of a DSP and a microprocessor, a plurality of microprocessors, one or more microprocessors in conjunction with a DSP core, or any other such configuration.

The memory 264 may include a cache memory (e.g., a cache memory of the processor 260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 264 includes a non-transitory computer-readable medium. The memory 264 may store instructions 266. The instructions 266 may include instructions that, when executed by the processor 260, cause the processor 260 to perform the operations described herein. Instructions 266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 268 can include any electronic circuitry and/or logic circuitry to facilitate direct or indirect communication of data between the processor circuit 250, and other processors or devices. In that regard, the communication module 268 can be an input/output (I/O) device. In some instances, the communication module 268 facilitates direct or indirect communication between various elements of the processor circuit 250 and/or the system 100. The communication module 268 may communicate within the processor circuit 250 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, etc.) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

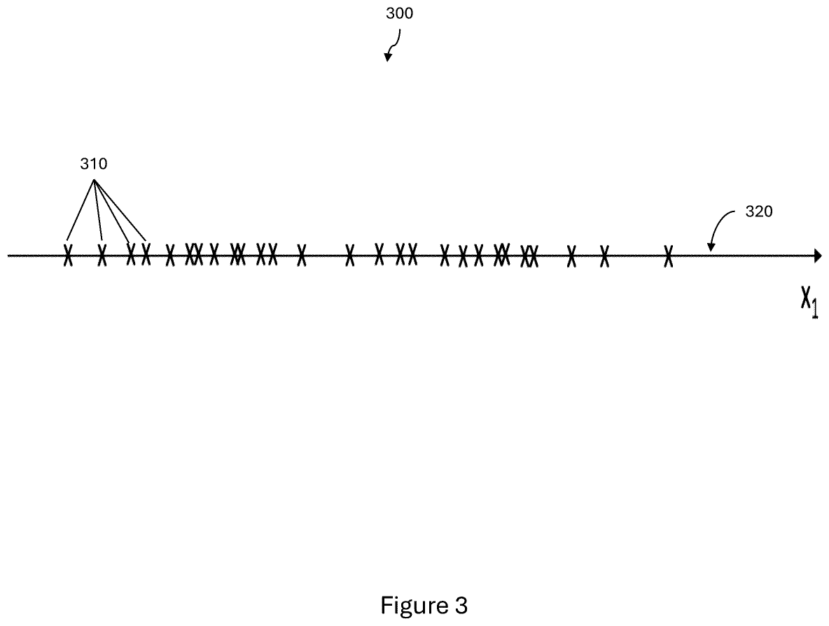

FIG. 3 is a one-dimensional representation 300 of entities 310 in a multidimensional space, in accordance with at least one embodiment of the present disclosure. The one-dimensional representation 300 includes a single axis 320. Each dimension or axis 320 of the multidimensional space represents a trait or feature of the entities 310. These traits of features can include numerical features such as net worth, total monthly deposit amount, total monthly transaction value, annual income, an account key, a party key, a number of active days per month, total monthly transaction volume on a credit or debit card, total monthly cash transaction volume, average monthly transaction volume, average monthly transaction value, or a combination thereof. The traits or features can also include non-numeric features such as a suspicious entity identifier, a suspicious financial institution identifier, an occupation, a party type, an account category, or an account classification. The multidimensional space can have dozens or even hundreds of dimensions or axes 320, although in some cases, 5-10 dimensions may be sufficient for accurate peer grouping. The position of each entity 310 along the axis 320 is indicative of that entity's value of the feature represented by the axis 320.

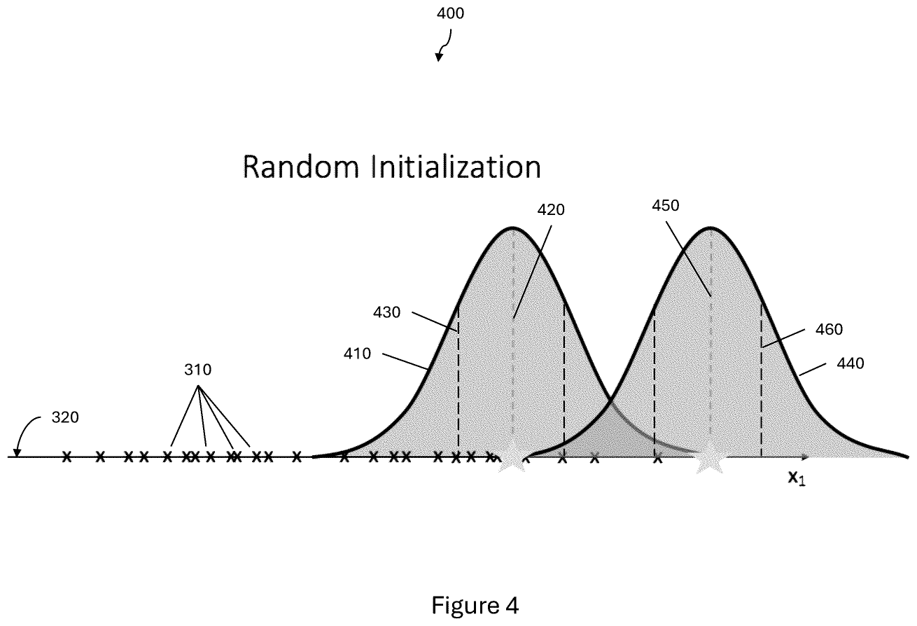

FIG. 4 is a schematic, diagrammatic representation of an example cluster initialization process 400, in accordance with at least one embodiment of the present disclosure. Visible are the data points or entities 310 and dimension or axis 320 of FIG. 3. Also visible is a first cluster 410, with a mean value 420 and standard deviation 430, and a second cluster 440 with a mean value 450 and standard deviation 460.

In identifying clusters, a possible first step is to identify the number of clusters to split the dataset into. This may, for example, be a user input, which allows for a more flexible approach compared to hard clustering, where each observation belongs to exactly one cluster. For each identified cluster, a Gaussian model is generated, that has one dimension for each feature of the entities or data points 310. These models represent the statistical distribution of the data within each cluster, allowing for a probabilistic representation of the cluster. Initializing the clusters may, for example, begin with unlabeled data. Initially, based on the data distribution, the system must select how many segments to partition the data into. The system then randomly divides those data into defined cluster/distributions as shown below:

Metadata used for smart peer grouping is mostly static data of parties and their accounts, and may, for example, include: Occupation (e.g., for individuals only), Sophistication (text), Classification (text), Party Type (text), Party Age (e.g., for individuals: 0-18=minors, 18-25=students, 25-35=young professionals, 35-65=late career, 64+=retired, and/or the like. For businesses: 0-3=new business, 3+=existing business), Account Age (e.g., 0-3 months=new account, 3+ months=old account), and Activity Volume (e.g., for individuals: 0-40=low, 40+=high. For businesses: 0-50=low, 50+=high), Birth Date or Incorporation Date, Net Worth, and Annual Income. In each case, these are exemplary and fewer or more or different data may be used.

Initially, all the records may be unlabeled, so the system randomly assigns the data points to clusters, with a cluster number determined as a hyperparameter to start the model. The next step step is to calculate the means of the defined clusters, and the probability of each data point belonging to that cluster. Probabilistic assignment to clusters (expectation)—Calculate our expectation of Zi, a vector of probabilities that xi belongs to the Jth cluster for J=1 to J=k:

$$E [ {z}_{ij} ] = \frac{P ( x = {x}_{i} \vert μ = {μ}_{i} )}{{\sum }_{m = 1}^{k} P ( x = {x}_{m} \vert μ = {μ}_{m} )} \qquad ( EQN . 1 )$$

$$and$$

$$P ( x = {x}_{i} \vert μ = {μ}_{i} ) = \frac{1}{\sqrt{2 {πσ}_{j}^{2}}} {e}^{\frac{{( {x}_{i} - {μ}_{j} )}^{2}}{2 {σ}_{j}^{2}}} \qquad ( EQN . 2 )$$

E is the expectation of the instance i that it belongs to jth cluster, and P is conditional probability that, given the mean of the distribution j, what is the probability of Xi. When the process begins, the data is randomly divided into multiple distributions or clusters, and for each distribution a standard deviation is calculated, where μ is the mean, σ is the standard deviation, m is the cluster number from 1 to k, and x represents the actual data points. The system then calculates the matrix Zi for each cluster as shown below. Each raw value in the matrix will give us the probability of the data point that it belongs to cluster 1 through K.

$${z}_{i} = [ \begin{matrix}P ( {x}_{i} belongs to Cluster 1 ) \\ P ( {x}_{i} belongs to Cluster 2 ) \\ ⋮ \\ P ( {x}_{i} belongs to Cluster k )\end{matrix} ] \qquad ( EQN . 3 )$$

Once this step is complete, cluster optimization can begin.

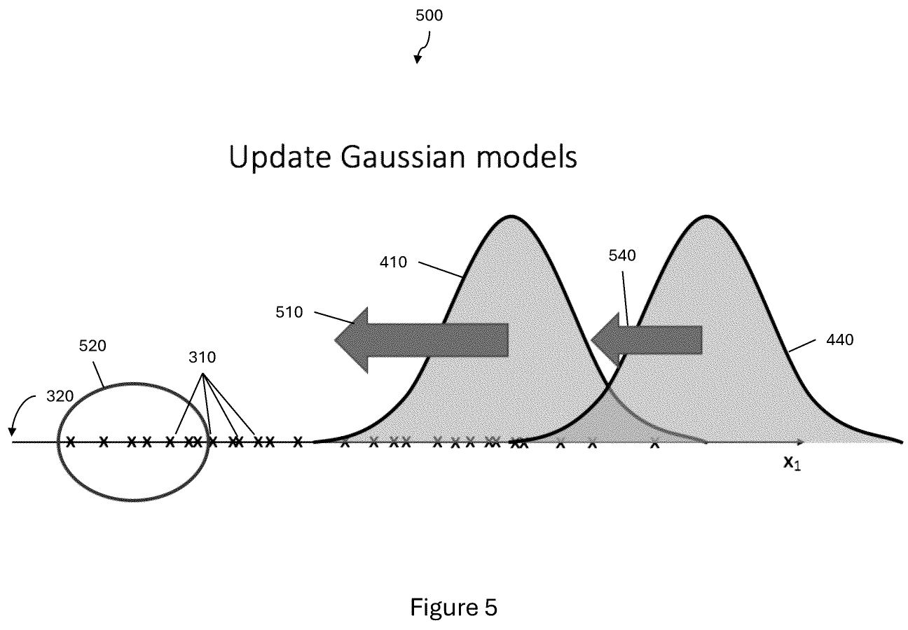

FIG. 5 is a schematic, diagrammatic representation of a Gaussian model update process 500, in accordance with at least one embodiment of the present disclosure. Visible are the data points 310 and axis 320 of FIG. 3, along with the Gaussian models 410 and 440. In the example shown in FIG. 5, Gaussian model 410 is moved along the axis 320 by an amount 510, while Gaussian model 440 is moved along the axis 320 by an amount 540.

For every observation, data point, or entity in the dataset, the method calculates the probability that that data point belongs to each cluster. This probability assignment is based on the likelihood of the observation given the parameters of each Gaussian model. Next, using the probabilities obtained in the previous step, the method updates the parameters of the Gaussian models to better fit the data. This iterative process refines the Gaussian models to better represent the underlying structure of the dataset.

Then, based on the probabilities calculated in the previous, step the system will shuffle the data points to different clusters based on their scores. Reformulating the Gaussian models (maximization) is achieved by shifting the mean and standard deviation of the randomly initiated Gaussian distributions using the mathematical formula as below

$${μ}_{j} = \frac{{\sum }_{i} E [ {z}_{i , j} ] {x}_{i}}{{\sum }_{i} E [ {z}_{i , j} ]} \qquad ( EQN . 4 )$$

$${σ}_{j} = \frac{{\sum }_{i} E [ {z}_{i , j} ] ( {x}_{i} - {μ}_{j} ) ( {x}_{i} - {μ}_{k} )}{{\sum }_{i} E [ {z}_{i , j} ]} \qquad ( EQN . 5 )$$

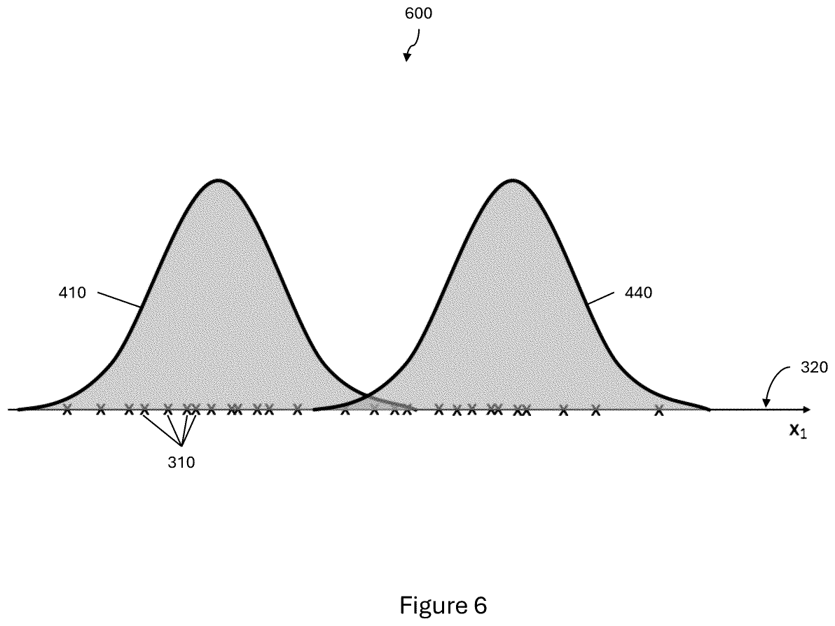

FIG. 6 is a schematic, diagrammatic representation of a Gaussian model convergence process 600, in accordance with at least one embodiment of the present disclosure. Visible are the data points 310 and axis 320 of FIG. 3, along with the Gaussian models 410 and 440. The method repeats the probability calculation and model updating steps until a convergence criterion is met. Convergence occurs when the assignments of observations to clusters stabilize (e.g., changes to the mean and standard deviation of each cluster fall below a threshold amount from one iteration to the next), indicating that the method has reached a stable solution.

However, in the case of categorical variables (e.g., text strings, etc.), it may not be possible to calculate mathematical expressions such as mean and standard deviation, so a more sophisticated approach to calculate the variation/similarity is used instead. For example, generalized Hamming distance is a measure that can be used to calculate the similarity between the categorical variables:

$${d}_{c} ( X , Y ) ≡ {\sum }_{j = 1}^{m} δ ( {x}_{i} , {y}_{j} ) \qquad ( EQN . 6 )$$

$$where$$

$$δ ( {x}_{i} , {y}_{j} ) = \{ \begin{matrix}0 , {x}_{j} = {y}_{j} \\ 1 , {n}_{i} \neq {y}_{i}\end{matrix} . \qquad ( EQN . 7 )$$

TABLE 1
K-Mode Cluster Assignments

| | Cluster 1 | Cluster 2 | Cluster 3 | Cluster |
|---|---|---|---|---|
| P1 | 0 | 2 | 2 | Cluster 1 |
| P2 | 3 | 3 | 3 | Cluster 1 |
| P3 | 3 | 1 | 3 | Cluster 2 |
| P4 | 3 | 3 | 1 | Cluster 3 |
| P5 | 1 | 2 | 2 | Cluster 1 |
| P6 | 3 | 3 | 2 | Cluster 3 |
| P7 | 2 | 0 | 2 | Cluster 2 |
| P8 | 2 | 2 | 0 | Cluster 3 |

Here, d_{c} means distance/similarity between X and Y, and δ indicates whether the two instances are similar or not. If both are close, the score will be 0, and otherwise it will be 1, where ‘n’ is a collection of datapoints whose j instance is not similar to the ‘y’ collection jth instance, and i/j denotes the instances of dataset where the system will take 1 point at a time and compare or calculate the similarity score. This is a notation for calculating similarity that will be familiar to a person of ordinary skill in the art.

It is noted that while the final similarity score will be mapped to 0 or 1, the system internally can use scores that can be greater than 1. This occurs mainly with categorical variables such as gender, occupation and region. For every data point, similarity values will be calculated with respect to each cluster. In an example, suppose a given data point has similarity scores of 3, 5, and 2 with regard to cluster 1, cluster 2, and cluster 3, respectively. The system would then apply a normalization such as 3/10, 5/10, and 2/10, yielding values of 0.3, 0.5, and 0.2. Since the datapoint has the highest similarity score with regard to cluster 2, the system will then assign it to cluster 2 with a similarity score value of 1, and the data point's similarity score with regard to the other clusters, cluster 1 and cluster 2, will be set to 0. Thus, ultimately, every similarity score will be mapped only to values of 0 or 1.

An intermediate step is to create a partition matrix, having the data points on its rows and the cluster number in its columns. Every data point has some similarity score with clusters based on that score data points are assigned to that specific cluster. Then the system runs the below optimization to see whether the assignment of data points to clusters is optimal or not. If it is not, then the system runs the iteration and ultimately assigns the data points to the correct clusters, including the possibility of assigning data points to multiple clusters as well, to achieve smart peer grouping.

Objective function to minimize below Expression.

$${F}_{c} ( W , Z ) = {\sum }_{l = 1}^{k} {\sum }_{i = 1}^{k} {w}_{li}^{α} {d}_{c} ( {Z}_{i} , {X}_{i} ) \qquad ( EQN . 8 )$$

This function maximizes the probability of assigning the data point to the correct clusters, where Zi represent each cluster, and and Xi is all data points. Thus, for each data point, calculate the similarity with each cluster Zi. In an example, if there are 4 clusters, then Xi will calculate the similarity with each of Z₁, Z₂, Z₃ and Z₄, where Fc-is a function for each combination c means Xi and Zi, dc is the similarity score, and wᵢⱼ is a weight for normalizing the similarity score of the ith record in the jth cluster. In the case of hard Kmode clustering, the value of w will be 0 or 1 only, but in the case of Fuzzy Kmode it can be a value between 0 and 1. Result Evaluation and Performance Testing: Comparison of Conceptual Fuzzy K Mean Vs Hard K-Mode Vs Fuzzy K-Mode.

Here, smart peer grouping results using fuzzy k-mode are compared with other clustering methods, based on a sample data with 147 records, a total of 35 attributes (of which 21 were selected, since 14 attributes had only one value for all data points). Four classes or clusters were used. In the below diagrams, it can be seen that the fuzzy k-mode method is more accurate than the other two methods, and has a computational overhead similar to that of hard k-modes.

TABLE 2
Average clustering accuracy and CPU
time for different clustering methods

| | Conceptual | Hard | Fuzzy |
|---|---|---|---|
| | K-means | K-modes | K-modes |
| Accuracy | 0.704 | 0.782 | 0.790 |
| CPU Time (sec) | 0.164 | 0.024 | 0.034 |

TABLE 3
Average clustering accuracy and CPU time for 10,000 objects

| | Conceptual | Fuzzy |
|---|---|---|
| | K-means | K-modes |
| Accuracy | 0.949 | 0.992 |
| CPU Time (sec) | 6.56 | 1.28 |

Below are two tables that show how the assignment works when using hard clustering Vs fuzzy clustering. The tables below also show how hard clustering performs vs. fuzzy k-mode, using labeled data for bank clients. As can be seen, Fuzzy k-mode assigns data points to the correct class or cluster 80% of the time, vs. 20% of the time for hard clustering.

TABLE 4
Hard K-modes, wᵢⱼ=

| | | | | Cluster | True |
|---|---|---|---|---|---|
| 1 | 2 | 3 | 4 | Assigned | Class |
| 0 | 1 | 0 | 0 | 2 | 2 |
| 1 | 0 | 0 | 0 | 1 | 2 |
| 1 | 0 | 0 | 0 | 1 | 2 |
| 1 | 0 | 0 | 0 | 1 | 2 |
| 1 | 0 | 0 | 0 | 1 | 2 |

TABLE 5
Fuzzy K-modes, wᵢⱼ=

| | | | | Cluster | True |
|---|---|---|---|---|---|
| 1 | 2 | 3 | 4 | Assigned | Class |
| 0.4999 | 0.4999 | 0.0001 | 0.0001 | 2 | 2 |
| 0.4928 | 0.4928 | 0.0139 | 0.0005 | 1 | 2 |
| 0.2030 | 0.7717 | 0.0218 | 0.0035 | 1 | 2 |
| 0.0037 | 0.9963 | 0.0000 | 0.0000 | 1 | 2 |
| 0.1389 | 0.8602 | 0.0008 | 0.0000 | 1 | 2 |

In an example, because the first row of Table 5 holds two similarity values of 0.4999, the data point represented by the first row can belong to cluster 1 as well as cluster 2, thus employing smart clustering to more accurately represent the data point. The same is true for row 2, but not for rows 3-5, which each belong to only one cluster. By employing soft/fuzzy clustering with the expectation maximization method of a Gaussian mixture model, the present disclosure overcomes the limitations of traditional hard clustering methods in AML efforts. This allows for more nuanced and probabilistic assignment of observations to clusters, capturing complex patterns and multi-layered structures in transaction data. This approach enhances the detection capabilities of AML systems by providing a more accurate representation of the underlying data distribution and facilitating the identification of suspicious activities.

While traditional clustering methods, such as K-means, use hard assignments where each observation belongs to exactly one cluster, the present disclosure employs soft/fuzzy clustering using Gaussian mixture models (GMMs). This allows for a more probabilistic representation of cluster assignments, where observations have probabilities of belonging to multiple clusters simultaneously.

Unlike traditional one-to-one mapping between entities and clusters, the present disclosure allows for more flexible cluster assignments. Entities can belong to multiple clusters simultaneously, accommodating the diverse patterns observed in anti-money laundering (AML) transactions. By capturing complex patterns and multi-layered structures in transaction data, the present disclosure enhances the detection capabilities of AML systems. It enables the identification of subtle relationships and sophisticated money laundering techniques that may be missed by traditional clustering methods. The present disclosure can integrate with existing AML systems and initiatives, to enhance their detection capabilities. By incorporating soft/fuzzy clustering with Gaussian mixture models into the AML framework, the present disclosure complements existing solutions and strengthens overall detection efforts, by offering a more sophisticated and flexible approach to clustering in the context of AML, allowing for better detection of suspicious activities and improved protection against money laundering threats. The smart peer grouping system of the present disclosure offers a number of advantages of existing systems, including but not limited to: enhanced detection accuracy, adaptability to evolving threats, reduced false positives, improved automation and efficiency, quick response to emerging threats, cost savings, improved regulatory compliance, and improved customer (e.g., financial institution) experience.

In summary, the present disclosure significantly enhances anti-money laundering (AML) efforts by improving detection accuracy, streamlining compliance processes, reducing costs, and providing deeper insights into financial transactions. By integrating soft/fuzzy clustering with Gaussian mixture models and leveraging the expectation maximization (EM) method, the present disclosure offers a sophisticated approach to AML data analysis, ensuring regulatory compliance and maintaining a competitive edge in the financial services industry.

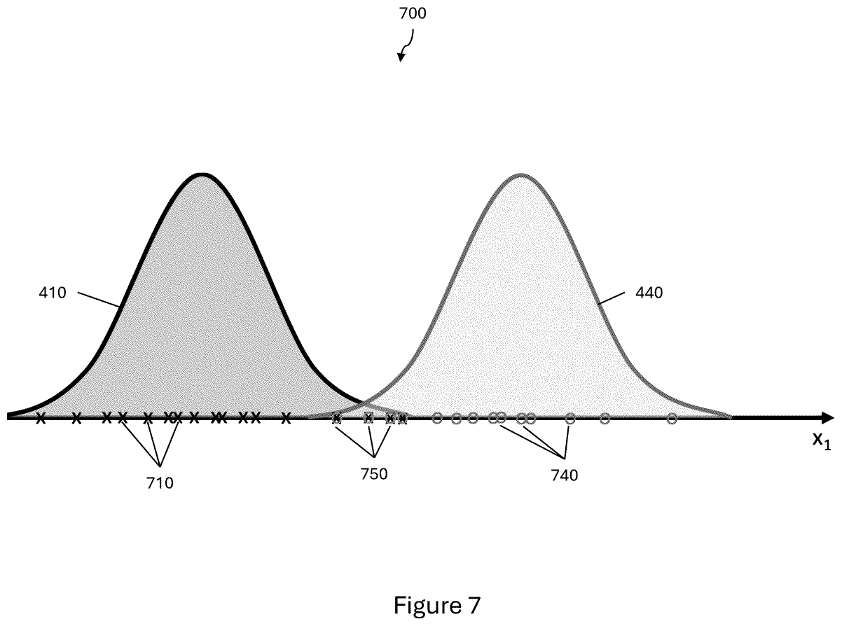

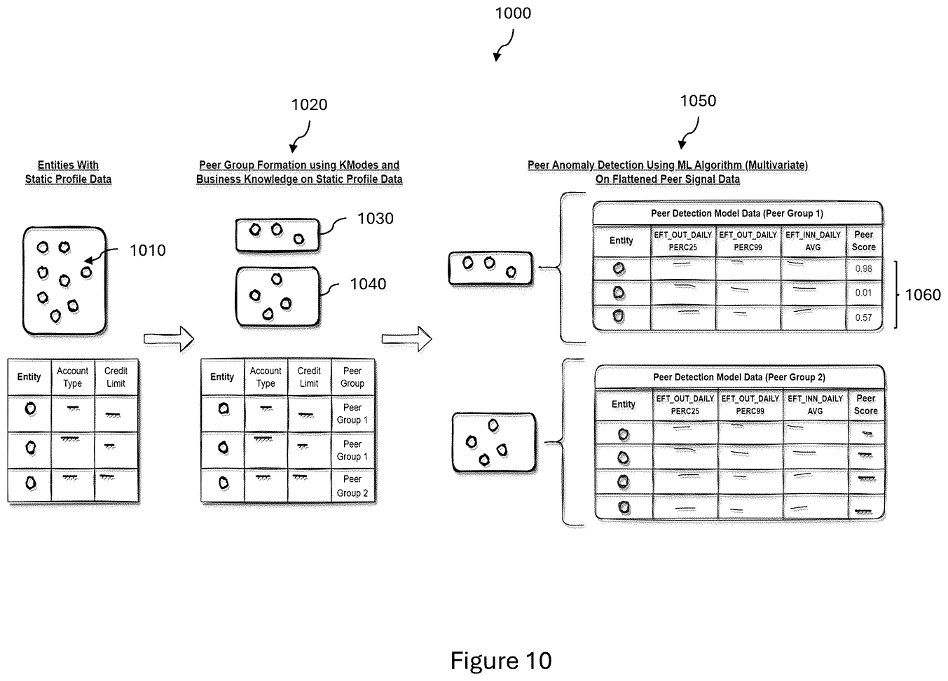

FIG. 7 is a schematic, diagrammatic representation of a completed cluster assignment 700, in accordance with at least one embodiment of the present disclosure. Visible are data points 710 that are assigned to cluster 410, data points 740 that are assigned to cluster 440, and data points 750 that are assigned to both clusters. The ability to assign entities (e.g., individuals, businesses, or organizations) to more than one cluster provides a more nuanced ability to determine the expected behavior of an entity, and thus to detect when the entity is acting in a manner inconsistent with its peer group. Such peer anomaly detection is discussed below in greater detail in FIGS. 10-13.

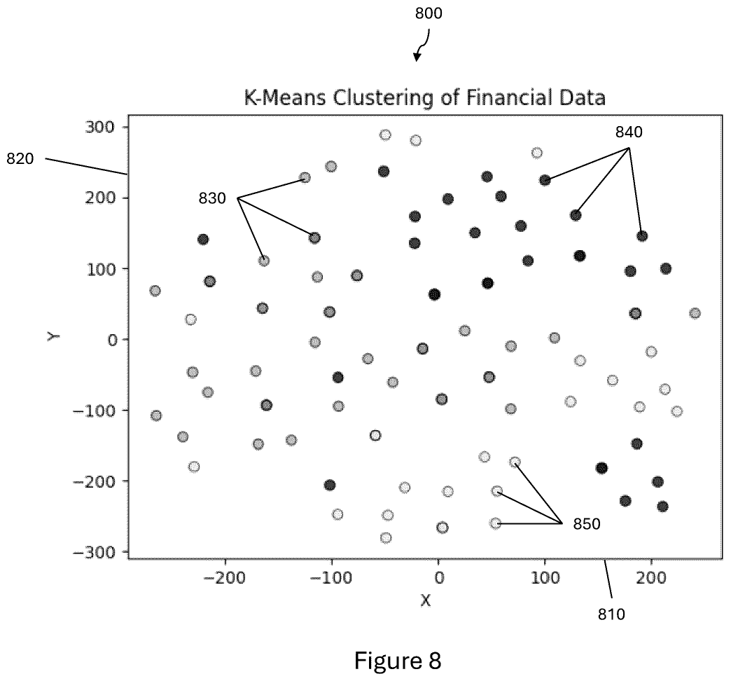

FIG. 8 is a schematic, diagrammatic representation of data clustering 800, in accordance with at least one embodiment of the present disclosure. Visible are two axes, an X-axis 810 and a Y-axis 820, along with data points 830 assigned to a first class or cluster, data points 840 assigned to a second class or cluster, and data points 850 assigned to a third class or cluster. In practice, clustering may occur in a multidimensional space with more than two dimensions (e.g., up to several hundred dimensions, although 5-10 dimensions may be preferred), and more than two clusters (e.g., 5-10 clusters) may be needed to fully describe the entities being analyzed.

Data points may typically be scattered in the mathematical space; and not well segregated. Table 6, below, shows some sample data points and their cluster assignments. Specifically, the table shows probability distribution of each data point across the K clusters. Higher values for a specific cluster mean that data point is assigned to that cluster only.

TABLE 6
Fuzzy k-mode clustering

| Cluster 1 | Cluster 2 | Cluster 3 |
|---|---|---|
| 0.3941 | 0.3942 | 0.2116 |
| 0.3349 | 0.3349 | 0.3302 |
| 0.2514 | 0.2514 | 0.4972 |
| 0.2464 | 0.2464 | 0.5071 |
| 0.2520 | 0.2520 | 0.4960 |
| 0.2584 | 0.2583 | 0.4833 |
| 0.3610 | 0.3610 | 0.2870 |
| 0.3629 | 0.3628 | 0.2474 |
| 0.3349 | 0.3349 | 0.3302 |
| 0.3799 | 0.3710 | 0.2401 |
| 0.3955 | 0.3956 | 0.2089 |
| 0.3571 | 0.3571 | 0.2858 |
| 0.3861 | 0.3862 | 0.2277 |
| 0.3853 | 0.3854 | 0.2292 |
| 0.3691 | 0.3691 | 0.2618 |
| 0.3590 | 0.3590 | 0.2820 |
| 0.3902 | 0.3903 | 0.2194 |
| 0.3843 | 0.3843 | 0.2314 |
| 0.2514 | 0.2513 | 0.4972 |
| 0.2703 | 0.2703 | 0.4594 |
| 0.3894 | 0.3850 | 0.2301 |

In Table 7, based on the threshold, if two probabilities are close to each other, then an ordinary clustering model will be confused in assignment, and so the smart peer grouping system of the present disclosure assigns that data points to two clusters. In an example, 99.0%-99.5% of entities are located in a single cluster, and approximately 0.5%-1.0% of entities are in multiple clusters (as shown in the final row of Table 7).

TABLE 7
Final Cluster Probabilities

| Cluster 1 | Cluster 2 | Cluster 3 |
|---|---|---|
| 0.016263 | 0.967446 | 0.016291 |
| 0.012206 | 0.975635 | 0.012159 |
| 0.017286 | 0.965433 | 0.017281 |
| 0.010735 | 0.978471 | 0.010794 |
| 0.999208 | 0.000631 | 0.000161 |
| 0.012053 | 0.975996 | 0.011951 |
| 0.021833 | 0.956203 | 0.021964 |
| 0.014191 | 0.971664 | 0.014145 |
| 0.019595 | 0.960955 | 0.01945 |
| 0.998048 | 0.001553 | 0.000399 |
| 0.000403 | 0.001573 | 0.998024 |
| 0.018267 | 0.963449 | 0.018284 |
| 0.007282 | 0.98549 | 0.007228 |
| 0.998575 | 0.001134 | 0.000291 |
| 0.012747 | 0.974557 | 0.012696 |
| 0.012843 | 0.974309 | 0.012848 |
| 0.010551 | 0.978973 | 0.010476 |
| 0.992087 | 0.006304 | 0.001609 |
| 0.015744 | 0.968531 | 0.015726 |
| 0.009976 | 0.980065 | 0.009958 |
| 0.006495 | 0.987053 | 0.006452 |
| 0.012654 | 0.974725 | 0.012621 |
| 0.013861 | 0.972429 | 0.01371 |
| 0.007189 | 0.985681 | 0.00713 |
| 0.497240 | 0.497240 | 0.00552 |

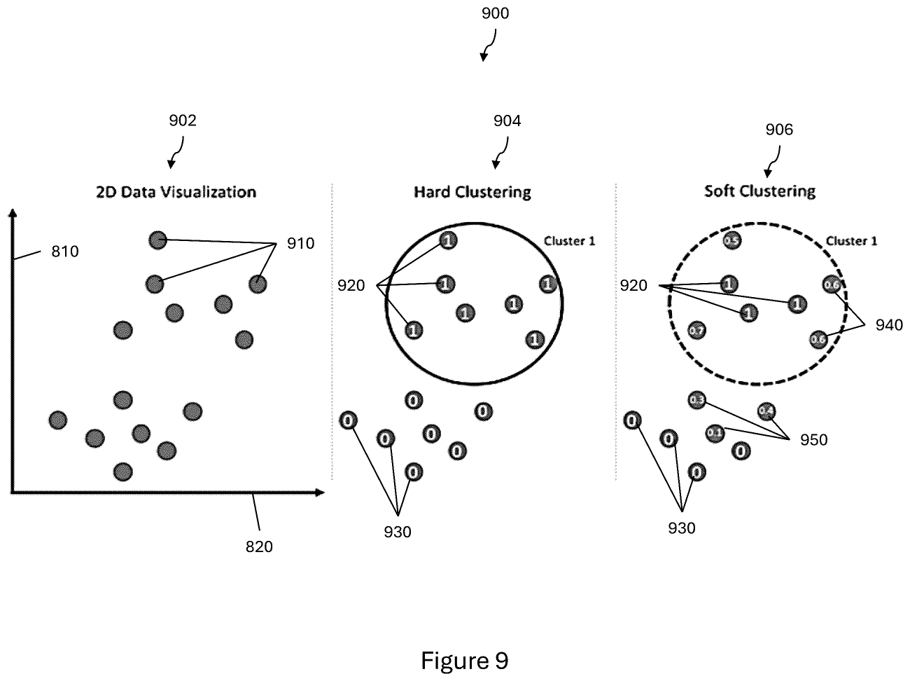

FIG. 9 is a schematic, diagrammatic comparison 900 between hard clustering and soft clustering of fuzzy k-mode clustering, in accordance with at least one embodiment of the present disclosure. Visible is a 2D data visualization 902, that includes an X-axis 810, Y-axis 820, and a number of entities or data points 910. Also visible is a hard clustering result 904, in which data points 920 (with a value of “1”) have been assigned to cluster 1, whereas other data points 930 (with a value of “0”) have been excluded from cluster 1. Also visible is a soft clustering result 906, in which data points 920 (with values of “1”) have been assigned to cluster 1, data points 930 (with values of “0”) have been excluded from cluster 1. However there are also data points 940 (with values of 0.5 or higher) that have been partially or probabilistically assigned to cluster 1, and data points 950 (with values between 0 and 0.5) that have been partially or probabilistically excluded from cluster 1.

FIG. 10 is a schematic, diagrammatic representation of a peer anomaly detection process 1000, in accordance with at least one embodiment of the present disclosure. Peer anomaly detection may, for example, involve determining whether the current behavior of an entity is inconsistent with the expected behavior of its peers (e.g., of other entities in a same cluster).

Visible are entities with static profile data 1010 with their distribution in X-Y space as described above. Also visible is a peer group formation process 1020, using k-modes and business knowledge on the static profile data, resulting in two clusters 1030, and 1040. Also visible is a peer anomaly detection step 1050 using a multivariate machine-learning (ML) algorithm on flattened peer signal data, resulting in peer anomaly scores 1060. In an example, a high peer anomaly score (e.g., close to 1.0) may be indicative that for the given entity, a transaction or group of transactions falls outside the statistical norms for that peer group (e.g., that cluster). The peer anomaly detection process 1000 may for example include the following steps:
Step 1: Collected data from a fraud detection database and preprocess it.
Step 2: Apply Simple K-mean to compare it result with Fuzzy algorithms.
Step 3: Run smart peer grouping on the data as described above, to obtain the probability distribution for each class or cluster.
Step 4: Compare against a threshold based on the tuning and assign multiple clusters to entities.
Step 5: Prepare the statistics to see the results.

For the specific use case of anomaly detection, along with summary data, the system will fetch party and account static profile data such as:
Account_key (a unique identifier for each account)
Party_key (a unique identifier for each party in the database)
Entity_sk (a flag indicating the entity is suspicious)
Occupation_cd (a string indicating the entity's occupation)
Party_type_cd (a string indicating the type of entity)
Client_net_worth
Party_curr_annual_income
Client_sophistication_cd (a string indicating qualitied of the entity)
Account_category_cd
Account_classification_cd
Acct_curr_st_total_net_worth

Peer formation is achieved by running the clustering model with the static attributes identified in above step. Clustering is the technique of splitting entities into separate groups depending on their attributes or behavior. Since behavior of user transactions can vary from one peer group to another, it can be helpful to create a separate anomaly machine learning model for each peer group or cluster. Creating separate anomaly models for different peer helps to better target the anomalous entity.

As we can see from the diagram, the system runs the fuzzy K-mode clustering model on static profile data to do peer formation. One or more peer groups will be assigned to each entity in this embodiment.

Clustering is an unsupervised learning method whose task is to divide the population or data points into several groups, such that data points in a group are more similar to other data points in the same group and dissimilar to the data points in other groups. It is basically a collection of objects based on similarity and dissimilarity between them. The K-mode method includes a machine learning algorithm used for clustering categorical data. As static data contains majority categorical variables as well as numerical variables, the fuzzy K-mode algorithm is particularly well suited for clustering it. This helps the system to group similar objects together based on their categories or attributes.

By using the fuzzy K-mode method, we can better understand and organize categorical data. This helps the system to discover patterns, similarities, and relationships between different categories, allowing users to make more informed decisions based on the characteristics of the data.

Below is an example of peer groupings from a sample of several million entities:

TABLE 8
Final Peer Groups

| | Population | Population |
|---|---|---|
| Peer Groups | Size (#) | Size (%) |
| Peer Group 0 | 3451524 | 24.34 |
| Peer Group 1 | 2139322 | 15.09 |
| Peer Group 2 | 1097993 | 7.74 |
| Peer Group 3 | 1605971 | 11.33 |
| Peer Group 4 | 515215 | 3.63 |
| Peer Group 5 | 1031002 | 7.27 |
| Peer Group 6 | 1531178 | 10.80 |
| Peer Group 7 | 564967 | 3.98 |
| Peer Group 8 | 1123333 | 7.92 |
| Peer Group 9 | 56066 | 0.40 |
| Peer Group 10 | 109551 | 0.77 |
| Peer Group 11 | 952894 | 6.72 |

### Peer Data Formation.

In this step, the system takes references from the meta data file and takes all the signals that are applicable for peers in a cluster. Below is an example query that can be run for all the entities and signals to obtain the final data.
select p.party_key as entity_key, p.entity_sk as entity_sk, ‘party’ as entity_type_cd, case when ds.day is null then date_format($$nullday, ‘yyyy-mm’) else date_format(ds.day, ‘yyyy-mm’) end as signal_detection_month, case when sum (trx_sum) is null then 0 else sum(trx_sum) end as signal_value from xdt_cds_v_inc_party as p join xdt_cds_v_inc_party_account_relation as pa on pa.party_sk=p.entity_sk left join xdt_sam_prf_tg_v_xdt_sam_agg_pgr_day_summary as ds on pa.party_sk=ds.party_sk and month(ds.day)=$$month and year(ds.day)=$$year and ds.transaction_type_cd=‘cashtelloanin’ where p.is_active < > 0 group by p.party_key, p.entity_sk, ds.party_sk, ds.day

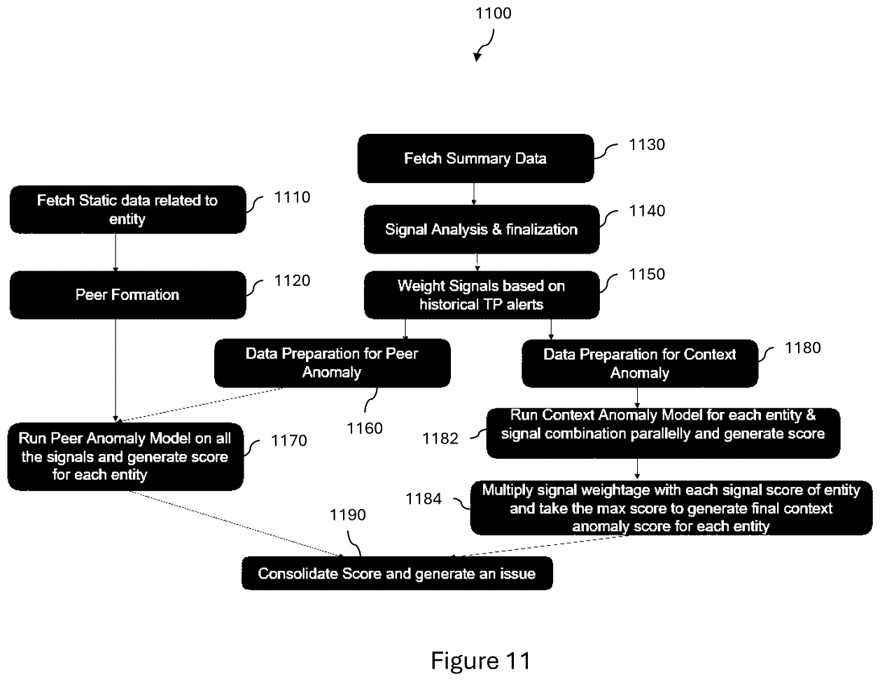

FIG. 11 shows a flow diagram of an example anomaly detection method 1100 according to at least one embodiment of the present disclosure. It is understood that the steps of method 1100 may be performed in a different order than shown in FIG. 11, additional steps can be provided before, during, and after the steps, and/or some of the steps described can be replaced or eliminated in other embodiments. One or more of steps of the method 1100 can be carried by one or more devices and/or systems described herein, such as components of the AML investigation system 100 and/or processor circuit 250.

The example of FIG. 11 shows a step-by-step process and architecture of the smart peer grouping system of the present disclosure.

All the steps described above are covered and arranged in the logical order of processing to obtain the final anomaly score. The flow diagram starts with fetching the data from summary tables, and running parallel processes with it.

In step 1130, the method begins with fetching summary data to analyze the signals and creating meta data. Fetching data for the signal analysis, the method is looking for all transaction types and their records.

In step 1140, from the metadata, the method fetches signals and prepares the data for peer and context anomalies. In some embodiments, this signal analysis is common for both peer and context anomaly detection. From the same data the method includes scanning for the transactions, transaction types, and any alerts raised on them, to assign the weightage.

In step 1150, the method includes weighting the signals based on historical transaction alerts. Signal weightage will help the system choose the subset of the signals on which it will focus while running the model. Signal weightage defines or specifies the relative importance of a given the signal, as compared with other signals, based on the true positive (TP) raised on the transaction types, where weightage of the signal is decided by how many times an alert is raised on this transaction type. For example, if on the card transaction type there are more alerts alert, then card-related signals will have higher weightage than cash or other transaction types. Accordingly, the method includes adding weight metadata to the signals, for both peer anomaly detection and context anomaly detection. In an example, peer anomaly detection may require one month of data, whereas context anomaly detection may require at least 6 months of data.

Execution then proceeds to both step 1160 and step 1180.

In step 1160, the method includes preparing the data for peer anomaly detection. Execution then proceeds to step 1170.

A parallel process is also running to, in step 1110, fetch the static account and party data to run peer grouping. The system may for example run a script to fetch the data for peer formation, including static party and account data.

In step 1120, the clusters or peer groups are formed as described above. The result of this will be used in peer modeling, so the entire dataset (including all entities) is divided into multiple peer groups.

This may for example involve using a fuzzy K-mode method to segment the data into multiple clusters, as described above, using similarity and mode calculations according to the following formula:

$$d ( X , Y ) = {\sum }_{j = 1}^{m} δ ( {x}_{j} , {y}_{j} ) \qquad ( EQN . 9 )$$

$$δ ( {x}_{j} , {y}_{j} ) = \{ \begin{matrix}0 , {x}_{j} = {y}_{j} \\ 1 , {x}_{j} \neq {y}_{j}\end{matrix} . \qquad ( EQN . 10 )$$

Where d is the similarity score, X, Y are the data points for which similarity is being calculated, and the function δ yields 0, 1 values depending on the similarity.

Execution then proceeds to step 1170.

In step 1170, the method includes running the peer anomaly detection model on all of the signals and generating a peer anomaly score for each entity. The peer anomaly detection model may for example include an isolation forest algorithm. Execution then proceeds to step 1190.

In step 1180, the method includes preparing the data for context anomaly detection.

In step 1182, the method includes running the context anomaly detection model for each entity and signal combination in parallel, and generating a context anomaly score for each entity. The context anomaly detection model may for example include an isolation forest algorithm.

In step 1184, the method includes multiplying the signal weightage with each signal score of each entity, and taking all of the maximum scores to generate a final context anomaly score for each entity. Execution then proceeds to step 1190.

In step 1190, the method includes consolidating the peer anomaly scores and context anomaly scores for each entity and, where the combined score exceeds a threshold, generating an issue for that entity. Scores may for example be in a range from −1 to 1, and may be normalized and added or otherwise combined. If the consolidated result is greater than certain threshold values then it may be raised as alert.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein.

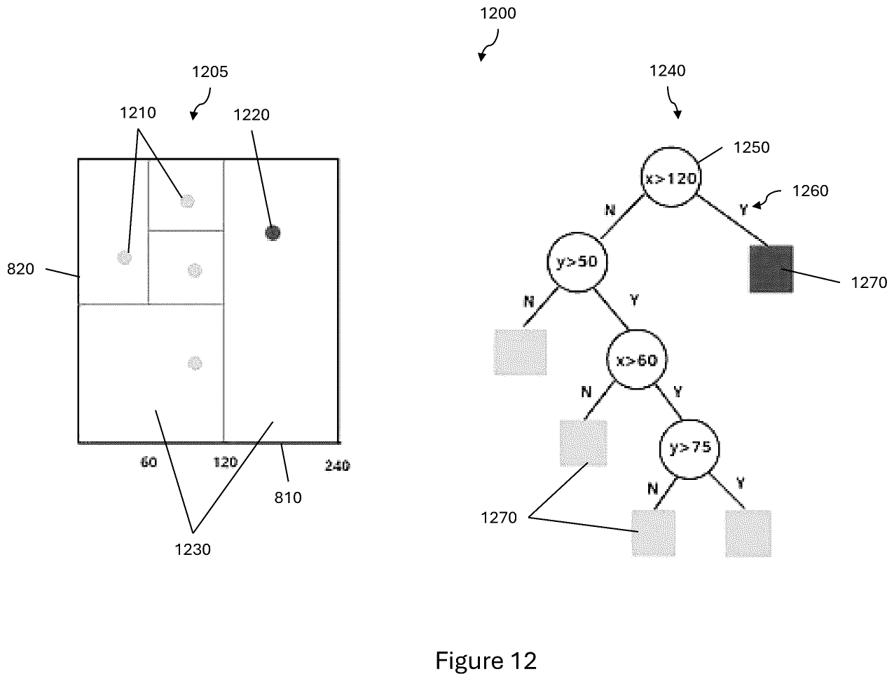

FIG. 12 is a representation of an example isolation forest model 1200, in accordance with at least one embodiment of the present disclosure. The model 1200 includes a graph 1205 with an X axis 810, a Y-axis 820, normal data points 1210, and an anomalous data point 1220. The data points are segregated into partitions 1230, where each partition 1230 represents a region isolated by the decision boundaries. The model 1200 also includes a decision tree 1240 which includes conditionals 1250, conditions 1260, and results 1270, where each result 1270 represents a data point 1210, 1220 on the graph 1205, such that the decision tree shows the path taken to isolate a particular data point.

FIG. 12 illustrates the working of an Isolation Forest model, which is used for anomaly detection. The model consists of two parts: a graphical representation 1205 and a decision tree 1240. In the graphical representation 1205, the X-axis 810 and Y-axis 820 plot the values of two variables from the dataset. The normal data points 1210 are plotted in lighter shades, while the anomalous data point 1220 is shown in a darker shade. The data points are divided into several partitions 1230, representing the regions isolated by the decision boundaries created by the Isolation Forest algorithm.

The decision tree 1240 consists of conditionals 1250 and conditions 1260 that are used to split the data points based on their feature values. Each node in the tree represents a decision point, where the dataset is split based on a condition, such as x>120 or y>50. The leaves of the tree (results 1270) represent the isolated partitions where each data point ends up. This helps to identify the path taken to isolate a particular data point. In the Isolation Forest algorithm, an objective is to recursively divide the data space using randomly selected features and split values. Anomalies are isolated quickly, in fewer partitions, because they have attribute values that are significantly different from the majority of the data points. In FIG. 12, the anomalous data point 1220 is quickly isolated by the decision tree, indicating it as an anomaly.

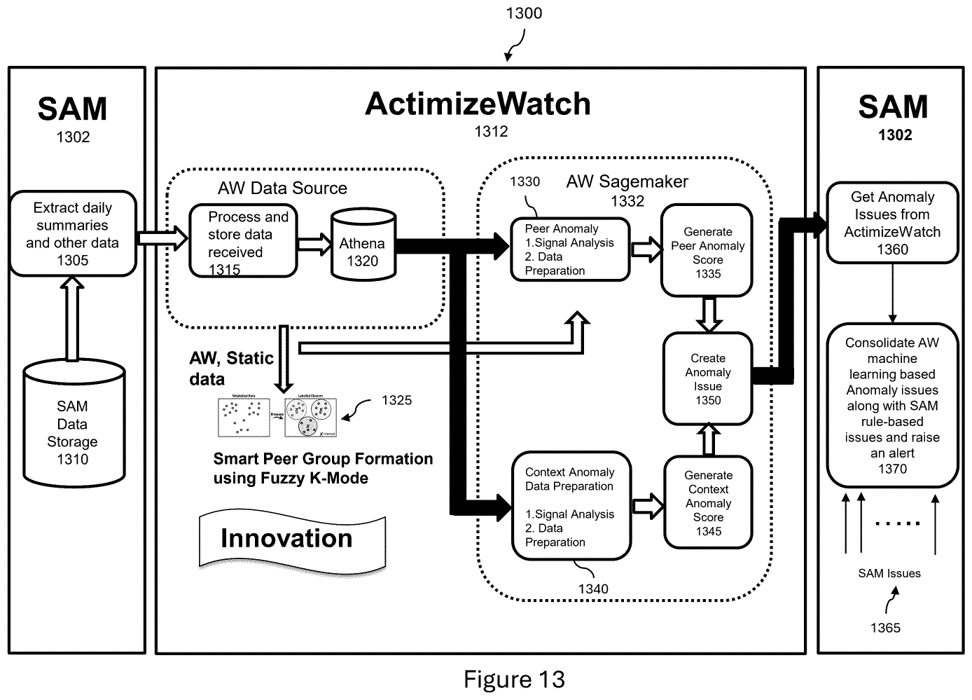

FIG. 13 is a schematic, diagrammatic representation, in block diagram form, of at least a portion of an example anti-money laundering investigation system 1300, in accordance with at least one embodiment of the present disclosure. In a suspicious activity monitoring module 1302, a data extraction module 1305 pulls monthly and daily transaction summaries and other data from a suspicious activity monitoring database 1310. This data is then passed to a watch system 1312, where a watch data source process 1315 processes and stores the received data in a watch database 1320. The data is also passed to an anomaly detection module 1332, and to a smart clustering or smart peer group formation module 1325.

The smart peer group formation module 1325 performs fuzzy K-mode clustering as described above, to organize all entities in the data into behavioral clusters or peer groups, such that entities can belong to more than one peer group. The data is then passed to a peer anomaly detection module 1330. Within the anomaly detection module 1332, a peer anomaly detection module 1330 performs signal analysis and data preparation, and then passes the prepared signals and data to a peer anomaly score computation module 1335.

Data from the watch data source process 1315 is also sent to a context anomaly detection module 1340 within the anomaly detection module 1332. The context anomaly detection module 1340 performs signal analysis and data preparation, then passes the signals and prepared data to a context anomaly score generation module 1345. The peer anomaly score and context anomaly score are then passed to a combiner 1350 to form a composite anomaly score and, if the composite anomaly score exceeds a threshold value, generates an anomaly issue.

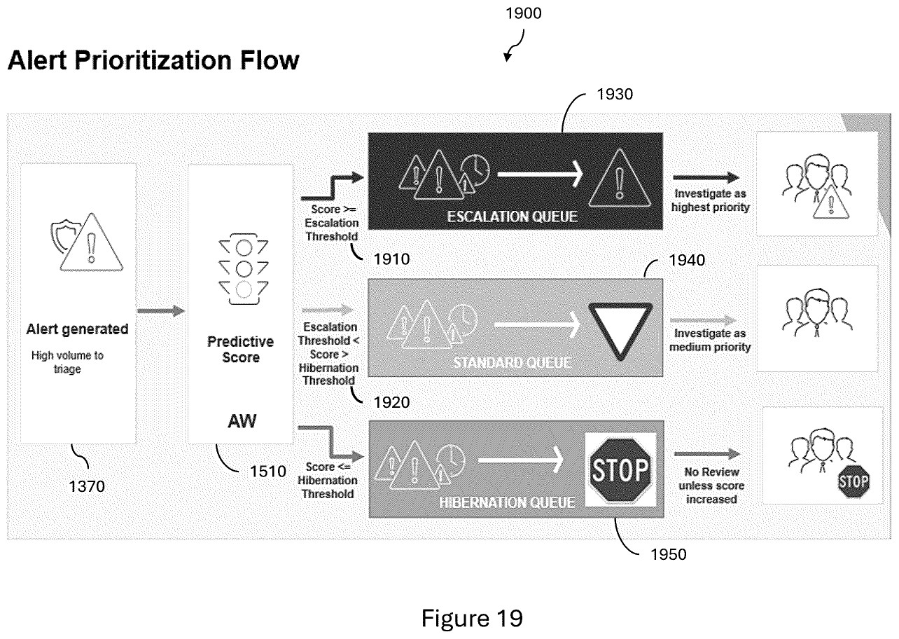

Within the suspicious activity monitoring module 1302, an anomaly issue module 1360 receives anomaly issues from the watch system 1312 and passes them to a consolidation module 1370, which consolidates the anomaly issues along with rule-based issues 1365 generated by the suspicious activity monitoring module 1302. If the issues exceed a specified level of severity (e.g., having more than a threshold combined anomaly score), the consolidation module 1370 will generate an alert, as described below in FIG. 19.

Table 9, below, shows example features used for calculating the anomalies. In an example, if there is a large collection of financial transactions from a bank, then most of these transactions are normal and follow typical patterns, such as regular monthly bills, groceries, and salaries. However, a few transactions might be unusual or suspicious, like a very large transfer to an unknown account, or a purchase from a strange location. These unusual transactions are the anomalies the system is designed to detect.

In this context, each transaction has features, such as:
Amount: How much money was involved in the transaction.
Location: Where the transaction took place.
Time: When the transaction occurred.
Type: What kind of transaction it was (e.g., ATM withdrawal, online purchase).

The Isolation Forest method can then be used to find these unusual transactions, by:
1. Dividing the Transactions. This involves splitting the transactions into groups based on their features. The method randomly chooses a feature (like the amount or location) and splits the transactions into smaller and smaller groups based on that feature. Each split divides the data into parts, some with high amounts, some with low amounts, some from certain locations, etc.
2. Isolating the Transactions. Normal transactions (the ones that follow typical patterns) tend to stay grouped together because they have similar feature values. Unusual transactions (anomalies) get separated quickly because their feature values are very different from the rest.
3. Finding Anomalies. After several rounds of splitting, the normal transactions remain grouped in larger sections, while the unusual transactions get isolated in their own smaller sections. The method measures how quickly each transaction gets isolated. Transactions that get isolated quickly are flagged as anomalies.

Table 9 uses variable names from an example suspicious activity monitoring system.

TABLE 9
Feature List
Athena tables used by Signal SQL

xdtsam_prf_tgv_xdt_sam_agg_monthly_summary
xdtcdsv_inc_party_account_relation
xdtcdsv_sam_trans_type
xdtsam_prf_tgv_xdt_sam_agg_daily_summary
xdtcdsv_inc_party

Table 10 shows normalization logic for both context anomaly detection and peer anomaly detection scores.

TABLE 10
Score Normalization

| | | NORMALIZED |
|---|---|---|
| MODEL_SCORE_FROM | MODEL_SCORE_TO | SCORE |
| −1 | −0.9 | 100 |
| −0.75 | −0.51 | 90 |
| −0.5 | −0.01 | 80 |
| 0 | −0.09 | 70 |
| 0.25 | −0.09 | 60 |
| 0.5 | −0.09 | 50 |
| 0.75 | −0.09 | 40 |
| 1 | −0.09 | 30 |

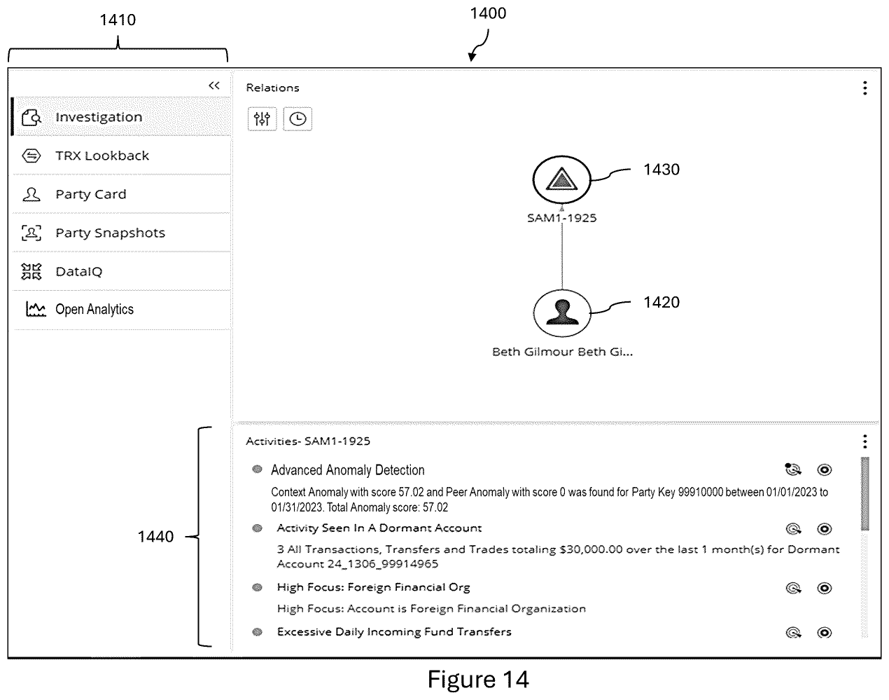

FIG. 14 shows a screen display 1400 of an example anti-money laundering investigation system, in accordance with at least one embodiment of the present disclosure. The screen display 1400 includes a menu 1410, and alert ID 1430, an alerted entity 1420, and an alert description 1440. This information may for example be presented to a user such as a human fraud investigator to help determine whether and how to act on the alert.

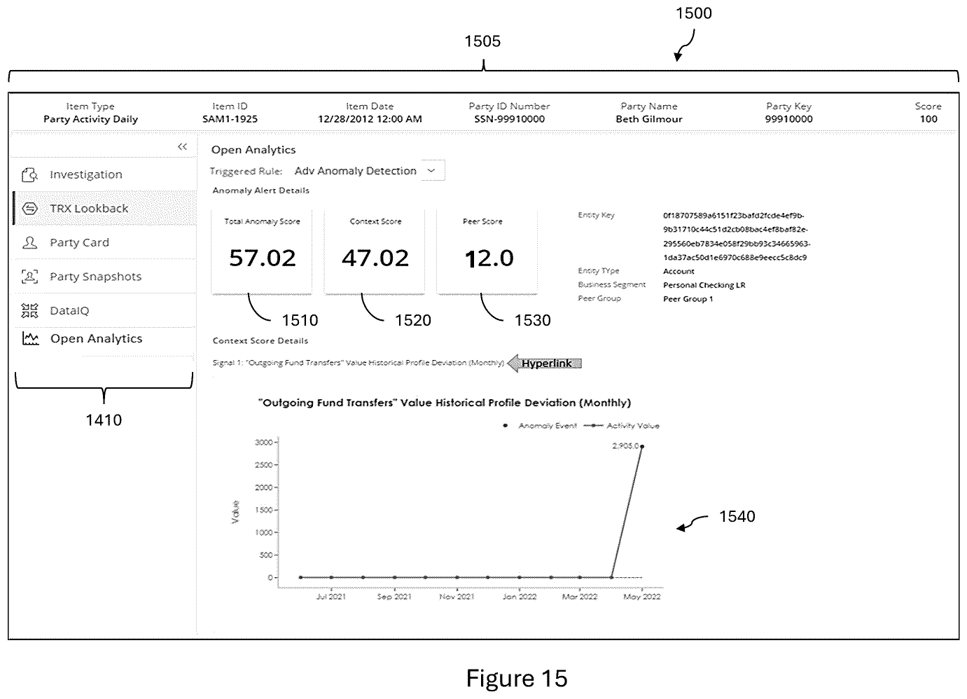

FIG. 15 shows a screen display 1500 of an example anti-money laundering investigation system, in accordance with at least one embodiment of the present disclosure. The screen display 1500 includes a menu 1410, an alert summary 1505, a total anomaly score 1510, and a historical deviation graph 1540. The total anomaly score 1510 may for example be a sum or other combination of the context anomaly score 1520 and the peer anomaly score 1530.

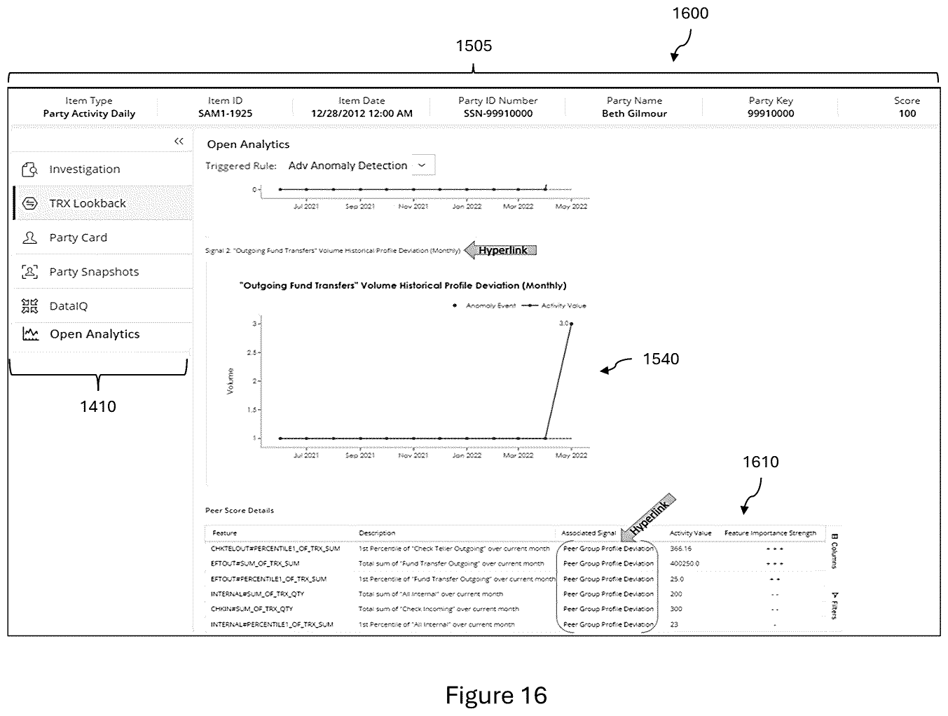

FIG. 16 shows a screen display 1600 of an example anti-money laundering investigation system, in accordance with at least one embodiment of the present disclosure. The screen display 1600 includes a menu 1410, an alert summary 1505, a historical deviation graph 1540, and a peer anomaly description 1610. The peer anomaly description may for example detail differences between the behavior of the alerted entity and the expected (e.g., mean, median, average, etc.) behavior of other entities in a peer group containing the alerted entity. Such information may be particularly useful where the entity belongs to more than one peer group. For example, if an entity is both a small business and a high-net-worth individual, the entity may display behavior that is within normal thresholds for one of these peer groups but outside of normal thresholds for the other peer group. Thus, by incorporating aspects of the smart peer grouping system, the anti-money laundering investigation system is able to detect behavioral anomalies (e.g., peer anomalies) that a traditional anti-money laundering investigation system might have missed, by grouping the entity into only one of the two peer groups to which it could reasonably belong.

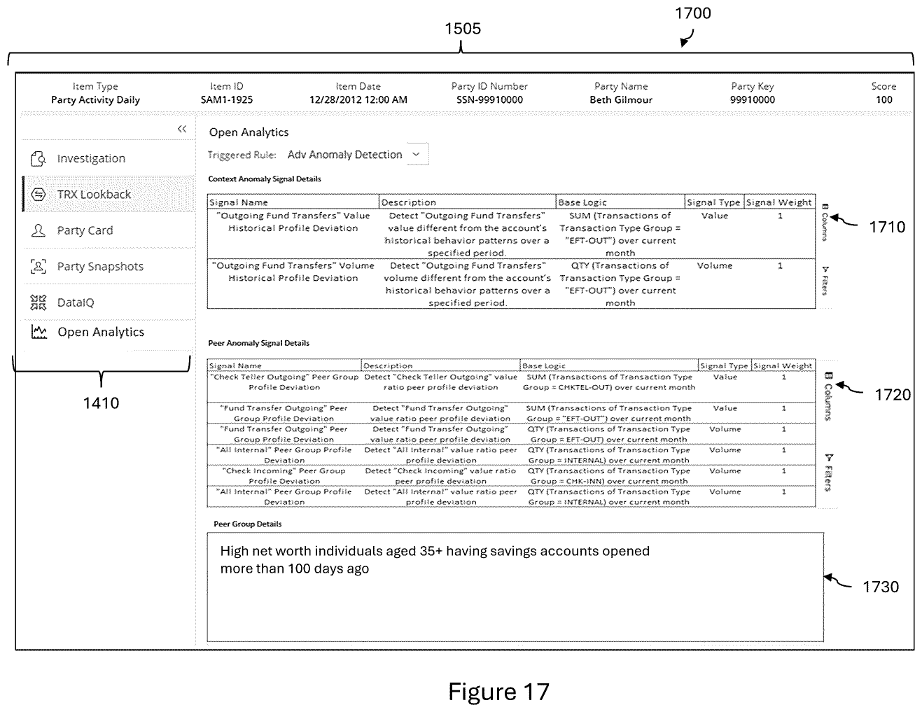

FIG. 17 shows a screen display 1700 of an example anti-money laundering investigation system, in accordance with at least one embodiment of the present disclosure. The screen display 1700 includes a menu 1410, an alert summary 1505, a context anomaly signal details table 1710, a peer anomaly signal details table 1730, and a peer group detailed description 1730. The peer group detailed description 1730 may for example provide a user (e.g., a human fraud investigator) with details about the peer group from which the alerted entity's behavior is deviating. This can provide insight into the kinds of anomalous behavior the entity has engaged in, and thus for example provide insight into whether the entity is a money mule for a money laundering operation.

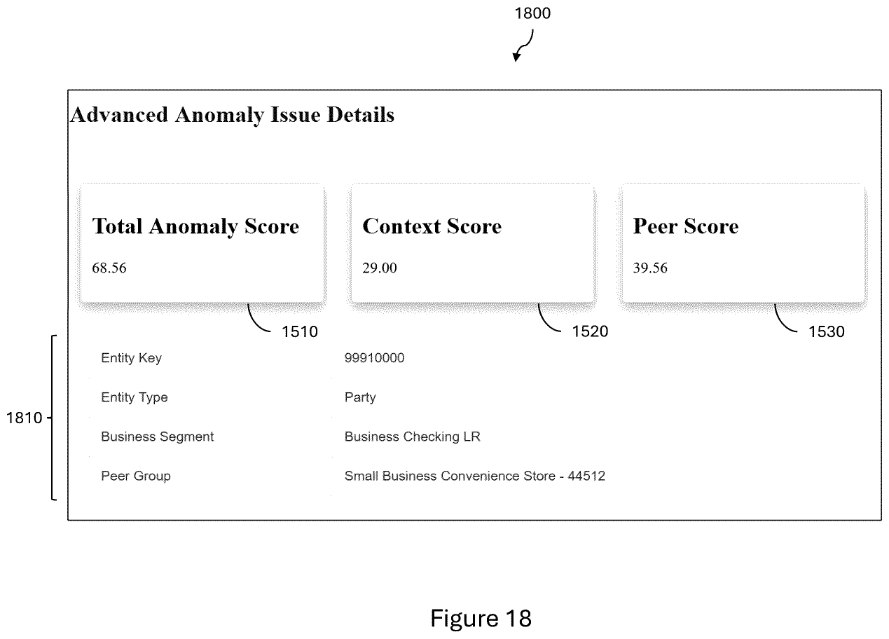

FIG. 18 shows a screen display 1800 of an example anti-money laundering investigation system, in accordance with at least one embodiment of the present disclosure. The screen display 1800 includes a total anomaly score 1510, a context anomaly score 1520, a peer anomaly score 1520, and an entity description 1810. This information may provide, at a glance, information about an alerted entity and the type of anomalous behavior the entity has exhibited.

FIG. 19 is a schematic, diagrammatic representation of an alert prioritization method 1900, in accordance with at least one embodiment of the present disclosure. In the example shown in FIG. 19, a generated alert 1370 is evaluated based on its total anomaly score 1510, which includes the peer anomaly score based on smart peer grouping as described above. If the total anomaly score 1510 is equal to or exceeds an escalation threshold 1910, then the alert is passed into an escalation queue 1930, where it will be investigated at the highest level of priority. In an example, at this level, investigation is required, and the account associated with the alert will be in a suspended state, since the party is suspected of fraud. If the total anomaly score 1510 is in between the escalation threshold 1910 and a hibernation threshold 1920, then the alert is passed into s standard queue, where it will be investigated at a medium priority level. In an example, at this level, investigation is not mandatory, but the financial institution may choose to investigate or monitor the account. If the total anomaly score 1510 is equal to or less than the hibernation threshold 1920, then the alert is passed into a hibernation queue, where it will not be investigated until or unless its total anomaly score 1510 increases beyond the hibernation threshold 1920. In an example, at this level, investigation is not required, and the account will not be suspended or monitored.

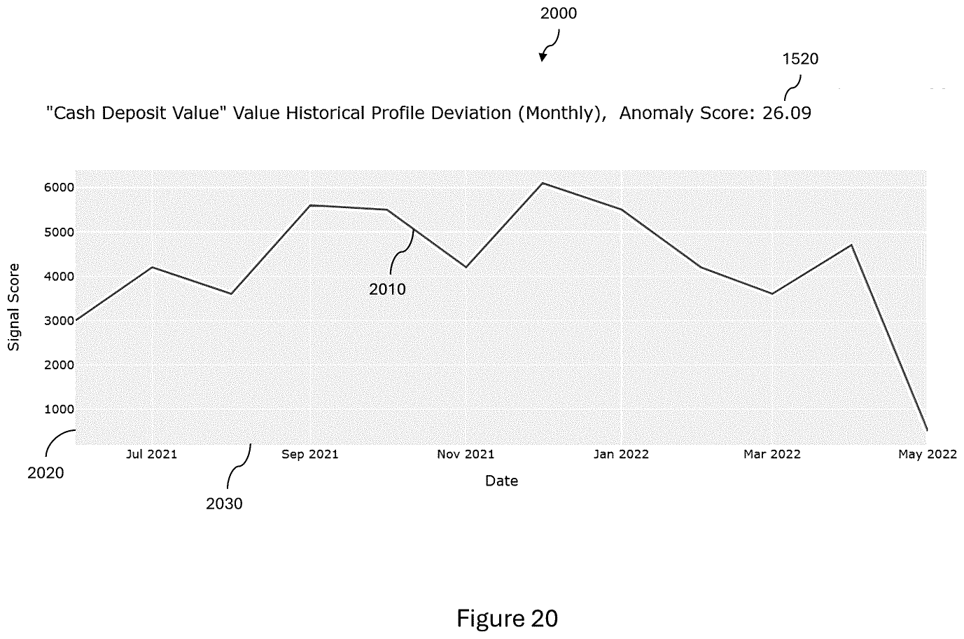

FIG. 20 is a graph 2000 of the “monthly cash deposit value” signal or feature over a 12-month period, in accordance with at least one embodiment of the present disclosure. The graph 2000 includes a curve 2010 measured against a signal score 2020 (e.g., U.S. dollars) and a date range 2030. In the example shown in FIG. 20, the “monthly cash deposit value” signal is within a range from 3000 to 6000 dollars, but then suddenly drops to less than $1000, resulting in a peer anomaly score 1520 of 26.09.

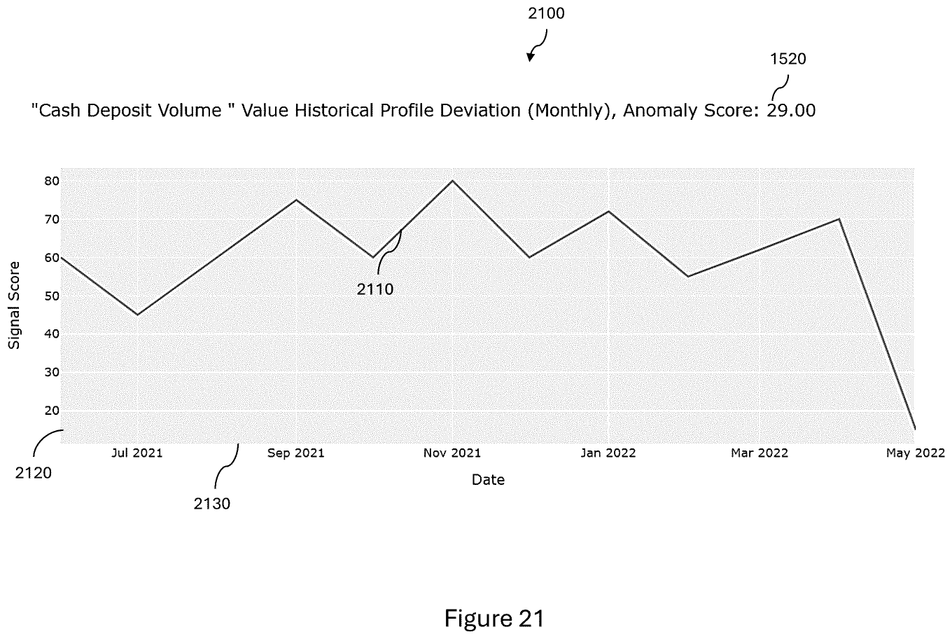

FIG. 21 is a graph 2100 of the “monthly cash deposit volume” signal or feature over a 12-month period, in accordance with at least one embodiment of the present disclosure. The graph 2000 includes a curve 2110 measured against a signal score 2120 (e.g., number of deposits) and a date range 2130. In the example shown in FIG. 21, the “monthly cash deposit volume” signal is within a range from 45 to 80 transactions, but then suddenly drops to less than 20 transactions, resulting in a peer anomaly score 1520 of 29.00. Different signals or features have different strengths for predicting peer anomalies. That is, some signals are highly predictive of peer behavior and thus peer anomaly, whereas others are only weakly predictive, as shown for example in Table 11:

TABLE 11
Relative Strength of Signal Features

| | | Peer | |
|---|---|---|---|
| | Signal | Median | Contribution |
| Signal Feature | Value | Value | Strength |
| cashin#percentile_1_of_trx_qty | 3 | 47 | −−− |
| cashin#percentile_4_of_trx_sum | 186 | 3356 | +++ |
| cashin#percentile_96_of_trx_sum | 464 | 7967 | −− |
| cashin#sum_of_trx_sum | 500 | 9281 | ++ |
| cashin#active_days | 3 | 15 | ++ |
| cashin#sum_of_trx_qty | 15 | 90 | + |

As can be seen in Table 11, of the six listed signals or features, the signal or feature “cashin#percentile_96_of_trx_sum” has the greatest utility in determining peer anomalies, whereas the signal or feature “cashin#percentile_1_of_trx_qty” has the least utility.

As will be readily appreciated by those having ordinary skill in the art after becoming familiar with the teachings herein, smart peer grouping, where an entity can belong probabilistically to more than one peer group, provides clear advantages over traditional peer grouping, where each entity can belong to only one cluster peer group. Accordingly, it can be seen that the smart peer grouping system fills a long-standing need in the art, by improving the ability of an anti-money laundering investigation system to detect that the entity is behaving anomalously as compared with one or more of the peer groups to which it belongs.

A number of variations are possible on the examples and embodiments described above. For example, different features or signals may be employed than those described herein. Different numbers or types of clusters may be used, and while the example of fuzzy K-mode clustering is used for illustrative purposes, a person of ordinary skill in the art will appreciate that the same “fuzziness” can be similarly applied to other clustering techniques without departing from the spirit of the present disclosure.

The technology described herein may be applied not only to the detection of money laundering (e.g., through mule accounts), but also other types of financial fraud, and indeed to any system where it is desirable to group unlabeled entities into behavioral clusters for the purpose of identifying peer anomalies.

Accordingly, the logical operations making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the smart peer grouping system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the smart peer grouping system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically identify suspected mule accounts, the system comprising:
a fraud management server having at least one processor and a non-transitory computer readable medium operably coupled thereto, the server being in electronic communication with a computing device of a bank, the processor comprising a distance calculation module and an expectation maximization clustering module, the server being in electronic communication with a database for storing a plurality of features for a plurality of entities associated with the bank, the computer readable medium comprising a plurality of instructions stored in association therewith that are accessible to, and executable by, the processor, to perform operations which comprise:
receiving an input identifying a number of desired clusters for a plurality of clusters;
in a multidimensional space comprising one dimension for each feature of the plurality of features, defining each cluster of the plurality of clusters as a Gaussian distribution in each dimension of the multidimensional space;
for each entity of the plurality of entities:
for each cluster of the plurality of clusters:
calculating a distance between the entity and the cluster; and
based on the distance, calculating a probability that the entity belongs to the cluster;
based on the probabilities and an expectation maximization, recalculating the Gaussian distributions until each entity belongs to at least one cluster of the plurality of clusters;
for an entity of the plurality of entities, in real time:
receiving at least one transaction associated with the entity;
based on a cluster to which the entity belongs, determining a peer anomaly score indicative of a probability that the at least one transaction is anomalous; and
if the peer anomaly score exceeds a threshold value, reporting the at least one transaction and the entity to a user.

2. The system of claim 1, wherein the entity belongs to more than one cluster of the plurality of clusters.

3. The system of claim 2, wherein the entity belonging to more than one cluster of the plurality of clusters improves an accuracy of the peer anomaly score.

4. The system of claim 2, wherein the entity belonging to more than one cluster of the plurality of clusters improves an accuracy of the clusters for describing a behavior of the entity.

5. The system of claim 4, wherein the improved accuracy of the clusters improves the utility of the clusters for anti-money-laundering (AML) analysis.

6. The system of claim 2, wherein the entity belonging to more than one cluster of the plurality of clusters reduces an amount of time required to calculate the clusters.

7. The system of claim 2, wherein the entity belonging to more than one cluster is based on a first probability of the entity belonging to a first cluster being within a threshold difference from a second probability of the entity belonging to a second cluster.

8. The system of claim 1, wherein:
the plurality of features includes numeric features and non-numeric features, and
for numeric features, a corresponding component of the distance is calculated using a probability, and
for non-numeric features, the corresponding component of the distance is calculated using a Hamming distance.

9. The system of claim 8, wherein the numeric features include at least one of a net worth, an annual income, an account key, a party key, a monthly deposit amount, a monthly transaction volume, or a number of active days per month.

10. The system of claim 8, wherein the non-numeric features include at least one of a suspicious entity identifier, a suspicious financial institution identifier, an occupation, a party type, an account category, or an account classification.

11. A computer-implemented method for automatically identifying suspected mule accounts, the method comprising:
with a fraud management server having at least one processor and a non-transitory computer readable medium operably coupled thereto, the server being in electronic communication with a computing device of a bank, the processor comprising a distance calculation module and an expectation maximization clustering module, the server being in electronic communication with a database for storing a plurality of features for a plurality of entities associated with the bank:
receiving an input identifying a number of desired clusters for a plurality of clusters;
in a multidimensional space comprising one dimension for each feature of the plurality of features, defining each cluster of the plurality of clusters as a Gaussian distribution in each dimension of the multidimensional space;
for each entity of the plurality of entities:
for each cluster of the plurality of clusters:
calculating a distance between the entity and the cluster; and
based on the distance, calculating a probability that the entity belongs to the cluster;
based on the probabilities and an expectation maximization, recalculating the Gaussian distributions until each entity belongs to at least one cluster of the plurality of clusters;
for an entity of the plurality of entities, in real time:
receiving at least one transaction associated with the entity;
based on a cluster to which the entity belongs, determining a peer anomaly score indicative of a probability that the at least one transaction is anomalous; and
if the peer anomaly score exceeds a threshold value, reporting the at least one transaction and the entity to a user.

12. The method of claim 11, wherein the entity belongs to more than one cluster of the plurality of clusters.

13. The method of claim 12, wherein the entity belonging to more than one cluster of the plurality of clusters improves an accuracy of the peer anomaly score.

14. The method of claim 12, wherein the entity belonging to more than one cluster of the plurality of clusters improves an accuracy of the clusters for describing a behavior of the entity.

15. The method of claim 14, wherein the improved accuracy of the clusters improves the utility of the clusters for anti-money-laundering (AML) analysis.

16. The method of claim 12, wherein the entity belonging to more than one cluster of the plurality of clusters reduces an amount of time required to calculate the clusters.

17. The method of claim 12, wherein the entity belonging to more than one cluster is based on a first probability of the entity belonging to a first cluster being within a threshold difference from a second probability of the entity belonging to a second cluster.

18. The method of claim 11, wherein:
the plurality of features includes numeric features and non-numeric features, and
for numeric features, a corresponding component of the distance is calculated using a probability, and
for non-numeric features, the corresponding component of the distance is calculated using a Hamming distance.

19. The method of claim 18, wherein the numeric features include at least one of a net worth, an annual income, an account key, a party key, a monthly deposit amount, a monthly transaction volume, or a number of active days per month.

20. The method of claim 18, wherein the non-numeric features include at least one of an entity identifier, a suspicious financial institution identifier, an occupation, a party type, an account category, or an account classification.
